(19) United States
(12) Patent Application Publication
(10) Pub. No.: US 2021/0162908 A1
(43) Pub. Date: Jun. 3, 2021

(54) FOLDING RAMP

(71) Applicants: Scott Drummond, Tuscaloosa, AL (US); Mark Manning, Tuscaloosa, AL (US)

(72) Inventors: Scott Drummond, Tuscaloosa, AL (US); Mark Manning, Tuscaloosa, AL (US)

(21) Appl. No.: 17/106,758

(22) Filed: Nov. 30, 2020

Related U.S. Application Data
(60) Provisional application No. 62/942,598, filed on Dec. 2, 2019.
(60) Provisional application No. 62/942,604, filed on Dec. 2, 2019.

(51) Int. Cl. B60P 1/43; B65G 69/28

(52) U.S. Cl. CPC B60P 1/435; B62D 33/023; B65G 69/287

(57) ABSTRACT

Disclosed are ramps. The ramps may include a frame and a traction surface. The frame may be attachable to a mounting surface. The frame may be adjustable from a collapsed state to a deployed state. When in the collapsed state the frame may be sized to be supported by the mounting surface. The traction surface may be supported by the frame. In the n the deployed state the frame and traction surface extend from the mounting surface and provide a transition from a tailgate to a ground surface

### PRIORITY CLAIM

This application claims the benefit of priority to U.S. Provisional Patent Application Ser. No. 62/942,604, fled on Dec. 2, 2019 and U.S. Provisional Patent Application Ser. No. 62/942,598, filed on Dec. 2, 2019, the content of each is hereby incorporated by reference herein in its entirety.

### SUMMARY

Disclosed are folding ramps. The folding ramps may include a frame and a surface supported by the frame. The frame may be collapsible and sized to fit inside a cavity defined by a tailgate.

### BRIEF DESCRIPTION OF THE FIGURES

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIGS. 1A and 1B show an example of a folding ramp consistent with this disclosure.

FIGS. 2A and 2B show an example of a folding ramp consistent with this disclosure.

Corresponding reference characters indicate corresponding parts throughout the several views. The exemplifications set out herein illustrate exemplary embodiments of the disclosure, and such exemplifications are not to be construed as limiting the scope of the disclosure any manner.

### DETAILED DESCRIPTION

There can be difficulty in loading items into a bead of a truck or other vehicle with an elevated bed and/or interior. For example, loading an all-terrain vehicle (ATV) or motorcycle into the bed of a truck may require the use of ramps. Traditional ramps use to allow the ATV or motorcycle to be wheeled into the bed have a fixed length and are not easily stored.

As disclosed herein, ramps may be foldable. The foldable nature of the ramps may allow for easy storage and/or integration of the ramps with vehicles. For example, the ramps disclosed herein may be connected to the tailgate of a truck.

The ramps disclosed herein may allow for more economical conversion of vans, busses, and other vehicles to permit and/or provide easier access for wheelchairs and other mobility devices used by disabled or otherwise mobility impaired individuals. For example, the ramps disclosed herein may be attached to vans and motors can be used to extend and retract the ramps so as to allow access to the van by those in a wheelchair.

As disclosed herein, the ramps may include a frame that allows the ramps to be adjustable from a first state, sometimes referred to as a collapsed state, to a second state, sometimes referred to as a deployed state. A traction surface can be connected to and supported by the frame. During deployment of the frame, the traction surface may form a surface upon which an ATV, motorcycle, wheelchair, etc. can travel from a ground surface to a tailgate or other structure of a vehicle or from the vehicle to the ground surface.

The ramps disclosed herein may include one or more supports. The supports may be permanently attached to the ramps or removeable. The supports may allow the frame to support additional weight and/or act as a safety in case of accidently overloading of the ramps.

The above discussion is intended to provide an overview of subject matter of the present patent application. It is not intended to provide an exclusive or exhaustive explanation of the invention. The description below is included to provide further information about the present patent application,

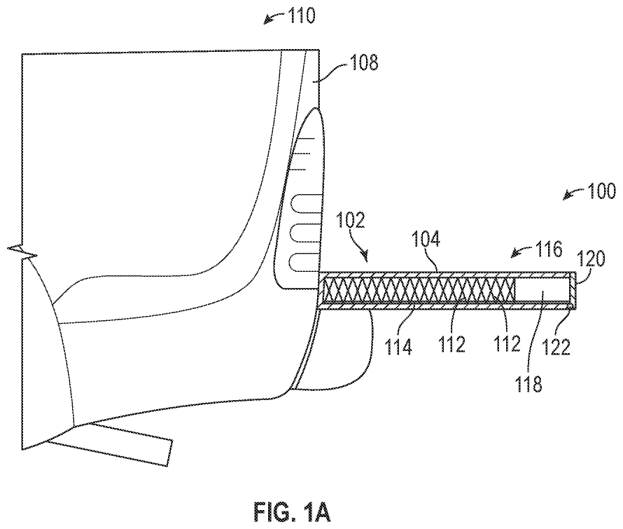

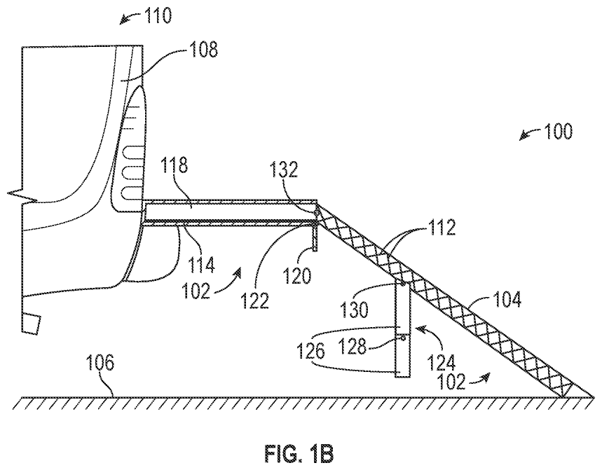

FIG. 1A shows an example of a folding ramp 100 in a collapsed state consistent with this disclosure, FIG. 1B shows an example of folding ramp 100 in an expanded state consistent with this disclosure. As shown in FIGS. 1A and 1B, folding ramp 100 can include a frame 102 and a traction surface 104. Frame 102 can support traction surface 104 as shown in FIG. 1B. Traction surface 104 can allow a user to drive or otherwise manipulate an item from a ground surface 106 into a bed 108 of a truck 110 or other vehicles. For example, folding ramp 100 may allow a user to load an ATV into bed 108.

Folding ramp 100 may also be used in passenger vehicles to facility loading and unloading of wheelchairs. For example, folding ramp 100 may connect to a frame or other body panel of a vehicle. Folding ramp 100 can be adjusted as disclosed herein to allow a wheelchair to traverse from ground surface 106 into the vehicle.

Frame 102 can be made of metals, polymers, or combinations thereof. For example, frame 102 can include metal cross members 112. Cross members 112 can also be made of polymers. Cross member 112 can allow frame 102 to be adjusted from a collapsed state as shown in FIG. 1A to a deployed state as shown in FIG. 1B.

Traction surface 104 can expand and collapse with frame 102. For example, traction surface 104 can be made of a plurality of slats or other members that move relative to one another. The movement can allow traction surface 104 to expand and collapse. Traction surface 104 can also include a texture. The texture can allow for improved traction. For instance, during wet weather or if the ATV has muddy tires, the texture of traction surface 104 can improve traction. Examples of a texture can include perforation and grooves that allow tires, shoes, etc. to achieve higher traction.

Frame 102 can be connected to one or more slides 114. Slides 114 can be connected to a surface of a tailgate 116. The surface of tailgate 116 can define a cavity 118 that frame 102 can fit within. Tailgate 116 can include a door 120 attached via a hinge 122. To deploy folding ramp 100, door 120 can be opened and frame 102 and traction surface 104 can be pulled out of cavity 118. For example, after opening door 120, frame 102 and traction surface 104 can translate on slides 114. Upon exiting cavity 118, frame 102 can rest on ground surface 106.

As shown in FIG. 1B, folding ramp 100 can include a support 124. Support 124 can be suspended from frame 102. Support 124 can allow frame 102 to support additional weight. Support 124 can be adjustable. For example, as shown in FIG. 1B, support 124 does not have to touch ground surface 106 when deployed. As such, should frame 102 sag or otherwise deform, support 124 can contact ground surface 106 to support frame 102. Thus, support 124 can act as a safety mechanism. For example, should folding ramp 100 be overloaded and deform, support 124 can contact ground surface 106 to prevent folding ramp 100 from collapsing.

The length of support 124 can also be adjustable. For example, support 204 can be multiple components, such as telescoping tubes 126, and a pin 128 can be used fix the length in various positions.

Support 124 can pivot around a pivot point 130. As such, support 124 can be rotated and stowed with frame 102 inside tailgate 116. Support 124 can also be attached to frame 102 via a pin at pivot point 130. Thus, support 124 can be removable for stowage.

While folding ramp 100 has been described as a single unit, folding ramp 100 can be multiple components. For example, folding ramp 100 can include two frames 102 that support traction surface 104 and multiple supports 124. The multiple frames 102 can be repositioned along a rod 132 or hinge 122. The repositioning of frames 102 can allow the frames 102 to be repositioned to accommodate ATVs or other items with differing wheel spacing.

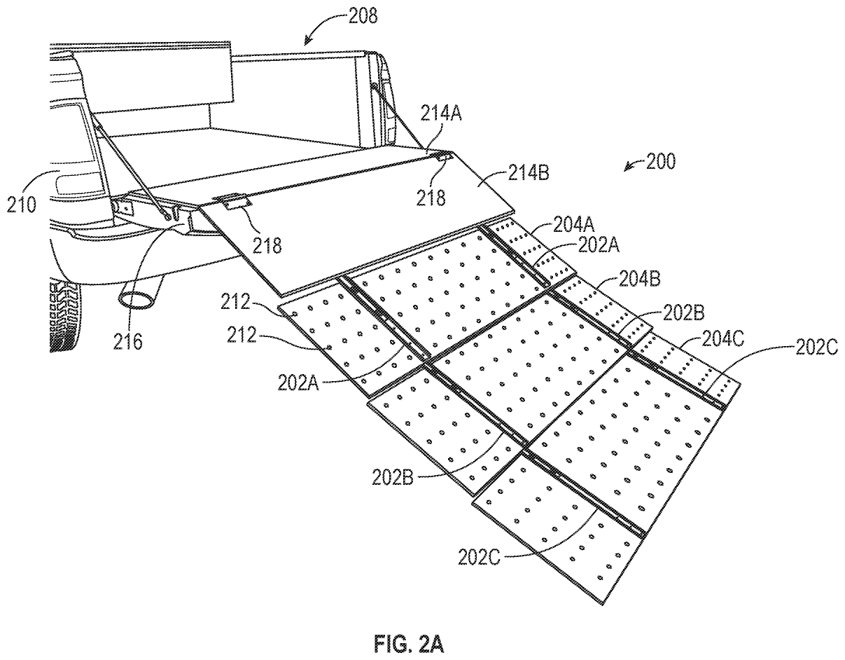

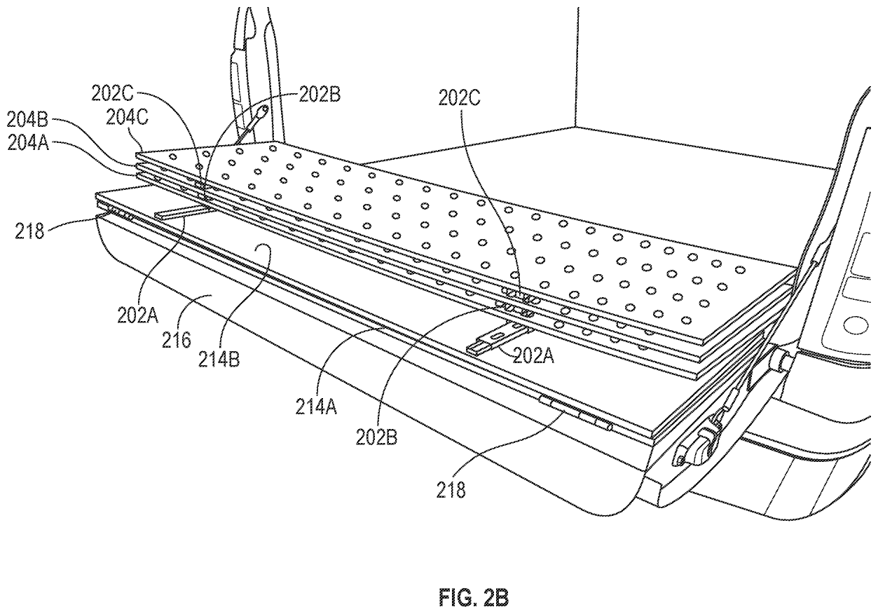

FIG. 2A shows an example of a folding ramp 200 in an expanded state consistent with this disclosure. FIG. 2B shows an example of folding ramp 200 in a collapsed state consistent with this disclosure. As shown in FIGS. 2A and 2B, folding ramp 200 can include one or more slides 202 (labeled individually as 202A, 202B, and 202C), which can form a frame, and one or more traction surfaces 204A, 204B, and 204C (collectively traction surfaces 204). Frames 202 can support traction surfaces 204 as shown in FIG. 2A. Traction surfaces 204 can allow a user to drive or otherwise manipulate an item from a ground surface, such as ground surface 106 shown in FIGS. 1A and 1B, into a bed 208 of a truck 210 or other vehicles. For example, folding ramp 200 may allow a user to load an ATV into bed 208.

Just as with folding ramp 100, folding ramp 200 may also be used in passenger vehicles to facility loading and unloading of wheelchairs. For example, folding ramp 200 may connect to a frame or other body panel of a vehicle. Folding ramp 200 can be adjusted as disclosed herein to allow a wheelchair to traverse from a ground surface into the vehicle.

Slides 202 can be made of metals, polymers, or combinations thereof. For example, each of slides 202 can include a metal channel and a runner or other component that slides in and out of the metal channel. Slides 202 can include polymer, ceramic, or metal rollers, hearings, etc. to easy adjusting folding ramp 200 from a collapsed state shown in FIG. 2B to a deployed state shown in FIG. 2A.

Traction surfaces 204 can expand and collapse with slides 202. For example, traction surfaces 204 can be made of panels that move relative to one another. The movement can allow traction surfaces 204 to expand and collapse. Traction surfaces 204 can also include a texture. The texture can allow for improved traction. For instance, during wet weather or if the ATV has muddy tires, the texture of traction surfaces 204 can improve traction. Examples of a texture can include perforations, such as perforations 212, and grooves that allow tires, shoes, etc. to achieve higher traction. Perforations 212 can be evenly and/or uniformly spaced as shown in FIG. 2B or random patterns of perforations.

Folding ramp 200 can include one or more mounting surfaces 214 (labeled individually as surfaces 214A and 214B). As disclosed herein, mounting surfaces 214 may be used to connect slides 204A to a tailgate 216. Mounting surfaces 214 can be connected to each other by one or more hinges 218. Mounting surface 214A can attached directly to a surface of tailgate 216. Thus, mounting surface 214A can allow folding ramp 200 to be connected to existing tailgates or other components of a vehicle as an aftermarket part. While FIGS. 2A and 2B shown mounting surface 214 attached to an exterior surface of tailgate 216, mounting surface 214A may also be a part of tailgate 216. For example, an exterior panel of tailgate 216 can be removed and mounting surface 214A can be attached to tailgate 216 in its place. Thus, folding ramp 200 can be an originally installed component of tailgate 216 or an aftermarket part.

Folding ramp 200 can include a support, such as support 124 shown in FIG. 1B. The support can be suspended from any one of slides 202 and/or tractions surfaces 204. The support can be adjustable and does not have to touch the ground when deployed. As such, should frame folding ramp 200 sag or otherwise deform, the support can contact the ground to support folding ramp 200. Thus, the support can act as a safety mechanism in the event folding ramp 200 is overloaded. The length of the support can also be adjustable. For example, the support can be multiple components as disclosed above with respect to support 124. The support can pivot around a pivot point and be stowed as described with respect to support 124.

### Examples and Notes

The following, non-limiting examples, detail certain aspects of the present subject matter to solve the challenges and provide the benefits discussed herein, among others.

Example 1 is a ramp comprising: a frame, the frame adjustable from a collapsed state to a deployed state, when in the collapsed state the frame is sized to fit inside a cavity defined by a tailgate; and a traction surface supported by the frame, wherein in the deployed state the traction surface provides a transition from an exterior surface of the tailgate to a ground surface.

In Example 2, the subject matter of Example 1 optionally includes a slide configured to mount to an interior surface of the tailgate.

In Example 3, the subject matter of any one or more of Examples 1-2 optionally include a support configured to be suspended from the frame when the frame is in the deployed state.

In Example 4, the subject matter of Example 3 optionally includes wherein a length of the support is adjustable.

In Example 5, the subject matter of any one or more of Examples 1-4 optionally include wherein the traction surface is a perforated surface.

In Example 6, the subject matter of any one or more of Examples 1-5 optionally include wherein the traction surface defines one or more grooves.

In Example 7, the subject matter of any one or more of Examples 1-6 optionally include wherein the frame includes one or more scissoring members.

In Example 8, the subject matter of any one or more of Examples 1-7 optionally include wherein the frame includes one or more slides.

In Example 9, the subject matter of any one or more of Examples 1-8 optionally include wherein a portion of the traction surface forms a portion of an exterior surface of the tailgate.

In Example 10, the subject matter of any one or more of Examples 1-9 optionally include a guardrail.

In Example 11, the subject matter of any one or more of Examples 1-10 optionally include wherein the ramp is a component of a vehicle.

Example 12 is a ramp comprising: a frame attachable to a mounting surface, the frame adjustable from a collapsed state to a deployed state, when in the collapsed state the frame is sized to be supported by the mounting surface; and a traction surface supported by the frame, wherein in the deployed state the frame and traction surface extend from the mounting surface and provide a transition from a tailgate to a ground surface.

In Example 13, the subject matter of Example 12 optionally includes wherein the mounting surface is a surface of the tailgate.

In Example 14, the subject matter of any one or more of Examples 12-13 optionally include wherein the mounting surface is mountable to a surface of the tailgate.

In Example 15, the subject matter of any one or more of Examples 12-14 optionally include wherein the frame comprises one or more slides.

In Example 16, the subject matter of any one or more of Examples 12-15 optionally include a support configured to be suspended from the frame when the frame is in the deployed state.

In Example 17, the subject matter of Example 16 optionally includes wherein a length of the support is adjustable.

In Example 18, the subject matter of any one or more of Examples 12-17 optionally include wherein the traction surface defines one or more groves.

In Example 19, the subject matter of any one or more of Examples 12-18 optionally include wherein the traction surface is a perforated surface.

In Example 20, the subject matter of any one or more of Examples 12-19 optionally include a guardrail.

In Example 21, the subject matter of any one or more of Examples 12-20 optionally include wherein the ramp is a component of a vehicle.

Example 22 is a vehicle comprising: a tailgate; a frame attached to the tailgate, the frame adjustable from a collapsed state to a deployed state; and a traction surface supported by the frame, wherein in the deployed state the frame and traction surface extend from a surface of the tailgate and provide a transition from the tailgate to a ground surface.

In Example 23, the subject matter of Example 22 optionally includes a mounting surface attaching the frame to the tailgate, wherein when in the collapsed state the frame is sized to be supported by the mounting surface.

In Example 24, the subject matter of any one or more of Examples 22-23 optionally include wherein the tailgate includes a mounting surface, the frame attached to the mounting surface of the tailgate.

In Example 25, the subject matter of any one or more of Examples 22-24 optionally include wherein the frame comprises one or more slides.

In Example 26, the subject matter of any one or more of Examples 22-25 optionally include a support configured to be suspended from the frame when the frame is in the deployed state.

In Example 27, the subject matter of Example 26 optionally includes wherein a length of the support is adjustable.

In Example 28, the subject matter of any one or more of Examples 22-27 optionally include wherein the traction surface defines one or more groves or is a perforated surface.

In Example 29, the subject matter of any one or more of Examples 22-28 optionally include a guardrail.

In Example 30, the apparatuses or method of any one or any combination of Examples 1-29 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A ramp comprising:
a frame, the frame adjustable from a collapsed state to a deployed state, when in the collapsed state the frame is sized to fit inside a cavity defined by a tailgate; and
a traction surface supported by the frame,
wherein in the deployed state the traction surface provides a transition from an exterior surface of the tailgate to a ground surface.

2. The ramp of claim 1, further comprising a slide configured to mount to an interior surface of the tailgate.

3. The ramp of claim 1, further comprising a support configured to be suspended from the frame when the frame is in the deployed state.

4. The ramp of claim 3, wherein a length of the support is adjustable.

5. The ramp of claim 1, wherein the frame includes one or more scissoring members.

6. The ramp of claim 1, wherein the frame includes one or more slides.

7. The ramp of claim 1, wherein a portion of the traction surface forms a portion of an exterior surface of the tailgate.

8. The ramp of claim 1, further comprising a guardrail.

9. The ramp of claim 1, wherein the ramp is a component of a vehicle.

10. A ramp comprising:
a frame attachable to a mounting surface, the frame adjustable from a collapsed state to a deployed state, when in the collapsed state the frame is sized to be supported by the mounting surface; and
a traction surface supported by the frame,
wherein in the deployed state the frame and traction surface extend from the mounting surface and provide a transition from a tailgate to a ground surface.

11. The ramp of claim 10, wherein the mounting surface is a surface of the tailgate.

12. The ramp of claim 10, wherein the mounting surface is mountable to a surface of the tailgate.

13. The ramp of claim 10, wherein the frame comprises one or more slides.

14. The ramp of claim 10, further comprising a support configured to be suspended from the frame when the frame is in the deployed state.

15. The ramp of claim 10, wherein the traction surface is a perforated surface.

16. The ramp of claim 10, further comprising a guardrail.

17. The ramp of claim 10, wherein the ramp is a component of a vehicle.

18. A vehicle comprising:
a tailgate;
a frame comprising a plurality of slides, the frame attached to the tailgate, the frame adjustable from a collapsed state to a deployed state; and
a traction surface supported by the frame,
wherein in the deployed state the frame and traction surface extend from a surface of the tailgate and provide a transition from the tailgate to a ground surface.

19. The vehicle of claim 18, further comprising a mounting surface attaching the frame to the tailgate, wherein when in the collapsed state the frame is sized to be supported by the mounting surface.

20. The vehicle of claim 18, wherein the tailgate includes a mounting surface, the frame attached to the mounting surface of the tailgate.
